(19) United States
(12) Patent Application Publication
(10) Pub. No.: US 2013/0266701 A1
(43) Pub. Date: Oct. 10, 2013

(54) KEARNS'S WET METHOD OF PRESERVING LETTUCE AND OTHER LEAFY VEGETABLES

(71) Applicant: JAMES LAWRENCE KEARNS, Jacksonville, FL (US)

(72) Inventor: JAMES LAWRENCE KEARNS, Jacksonville, FL (US)

(21) Appl. No.: 13/440,923

(22) Filed: Apr. 5, 2012

(51) Int. Cl. A23B 7/157; B65D 85/00; A23L 1/275

(52) U.S. Cl. 426/250; 426/419; 426/411

(57) ABSTRACT

This method of preserving lettuce and leafy vegetables is an advancement in current systems in that it will maintain freshness and nutritional value of lettuce and other leafy vegetables for far extended periods than current methods thus providing a greater food source for people. It will improve the environment by stretching food sources by preservation, to persons who need nourishment. It will maintain the moisture content and crispness of the lettuce, and the only foreign substances introduced are optional standard table salt and optional green food coloring in water which will preserve all properties and nutritional values of the lettuce and maintain freshness for up to or even beyond 90 days which is far greater than currently utilized systems. It will maintain the crispness of the lettuce throughout the duration of storage, for up to an unknown duration.

### FEDERALLY SPONSORED RESEARCH

Not Applicable

### SEQUENCE LISTING OR PROGRAM

Not Applicable

### BACKGROUND OF THE INVENTION

### FIELD OF THE INVENTION

This invention relates to a method of preserving iceberg and romaine lettuce and other leafy vegetables for an indefinite period of up to possibly 90 days and beyond in a fresh, crisp, leafy state: Once picked, lettuce and the aforementioned leafy vegetables will go bad after only a few days, to a maximum of two weeks, in the optimal situation in a refrigerated environment, and this method will provide for a shelf life of extended periods of time. This system will improve the environment by providing a greater fresh leafy vegetable food supply for all countries.

Currently utilized systems merely just refrigerate lettuce and leafy vegetables in a refrigerator or in a vacuum bag and this will only keep lettuce (further references to lettuce will be referring to all types of leafy vegetables) for a short time, an absolute maximum of about two weeks. A sealed bag or other sealed container is generally used to keep air from degenerating it more quickly, than just out in the open air of the refrigerated environment.

The Kearns's Wet Method of Preserving Lettuce and Other Leafy Vegetables will employ a vacuum environment by adding water and optional salt and optional green food coloring to allow it to remain in a fresh state by up to 90 or more days. The system will utilize a plastic bag and a plastic container to hold the water and a tube to help remove air from the bag so that moisture can travel by capillary action into the lettuce head to maintain the fresh state. The bag is sealed inside a vacuum environment and small holes are punched in the bottom of the bag into the stem of the lettuce, thus allowing for the water to be pulled into the lettuce. This method will absolutely ensure the lettuce will stay fresh for the maximum amount of time in a refrigerated environment. A variation will include a cellulose sponge filled with water and a porous filter over the sponge (not pictured in the diagram) to allow for the water to be sucked by the lettuce from the sponge and not to be free flowing water.

The process of preservation for The Kearns's Wet Method of Preserving Lettuce and Other Leafy Vegetables is as follows:
1. On the freshly harvested lettuce head with cut stem, remove any bad external leaves from the lower stem area.
2. Place a sealable plastic bag, such as a heavy gage “zip lock bag,” over the entire lettuce head.
3. Seal the upper opening around the approximately ¼″ diameter flexible tube that is approximately 6″ long using a standard twisty tie or rubber band.
4. Seal the bottom of the plastic bag around the lettuce stem with a rubber band.
5. Prick 3 to 4 holes of approximately 1″ depth into the lettuce stem and through the plastic bag with a needle or small paper clip type shaft.
6. Place ½ to 1 cup of filtered water into the bottom of the plastic container with optional green food coloring and optional salt of up to ¼ potency.
7. Now place the lettuce head into the plastic container with the optional plastic stop to hold the head stem in the center of the plastic container, making sure the lettuce stem is filly immersed into the water.
8. Seal the lettuce and plastic container in the vacuum bag, under vacuum, with the flexible tube hanging over the internal plastic container using a vacuum preservation food saver system.
9. Mark the date on the bag.
10. Place the vacuum sealed lettuce container in a refrigerated environment of between 35 to 40 degrees Fahrenheit.
11. The lettuce will remain in a fresh, crisp state for a minimum of 30 days to a maximum of (unknown duration).

Prior art systems include vacuum conditions and cooling of the lettuce, such as U.S. Pat. No. 2,832,690 filed by Wells on Apr. 29, 1958, but fail to include a substance for the catalyst to maintain freshness such as moisture content and a capillary action. Also U.S. Pat. No. 2,304,192 filled by Newton on Aug. 16, 1940, includes cooling by refrigeration, but did not introduce the moisture content agent or any moisture capillary action process or a vacuum environment.

### BRIEF SUMMARY OF THE INVENTION

This invention method will provide for a greater fresh lettuce and leafy vegetable food source for restaurants, cruise ships, merchant vessels and even for the general public, by maintaining lettuce and other leafy vegetables, in a fresh, crisp state for an extended period of up to and possibly beyond 90 days. It overcomes the problem of rapid spoilage even in a refrigerated environment. It will be particularly useful for the US Navy and other ships at sea which are deployed for extended periods of time without access to replenished food sources. It adds a source of moisture to the lettuce that will help to accommodate an environment similar to the time when the lettuce was still planted in the earth.

### BRIEF DESCRIPTION OF THE SEVERAL VIEWS OF THE DRAWING

FIG. 1, shows the system with detailed views of the required items.

Item 1 shows the sealed cellophane bag with the upper and lower seals enclosing an individual lettuce head.

Item 2 depicts water vapor that will envelop the lettuce head on the outside of the sealed plastic bag.

Item 3 shows a standard plastic bag such as a “zip lock bag” only without the seal system on top.

Item 4 shows a plastic container of sufficient strength to maintain its shape under vacuum from a standard vacuum food preservation machine.

Item 5 shows a normal lettuce head.

Item 6 shows the lettuce stem.

Item 7 shows the liquid catalyst.

Item 8 shows the pricked holes in the end of the lettuce stem.

Item 9 shows a plastic stop to maintain the lettuce in the water.

Item 10 shows standard twisty tie or rubber band that will close the plastic bag.

Item 11 shows a small plastic line that will exit the bag, but remain in the vacuum area, to pull air from the bag, when it is placed under vacuum.

Item 12 shows a standard rubber band.

Item 13 shows the upper seal.

Item 14 shows the lower seal.

### DETAILED DESCRIPTION OF THE PREFERRED EMBODIMENT

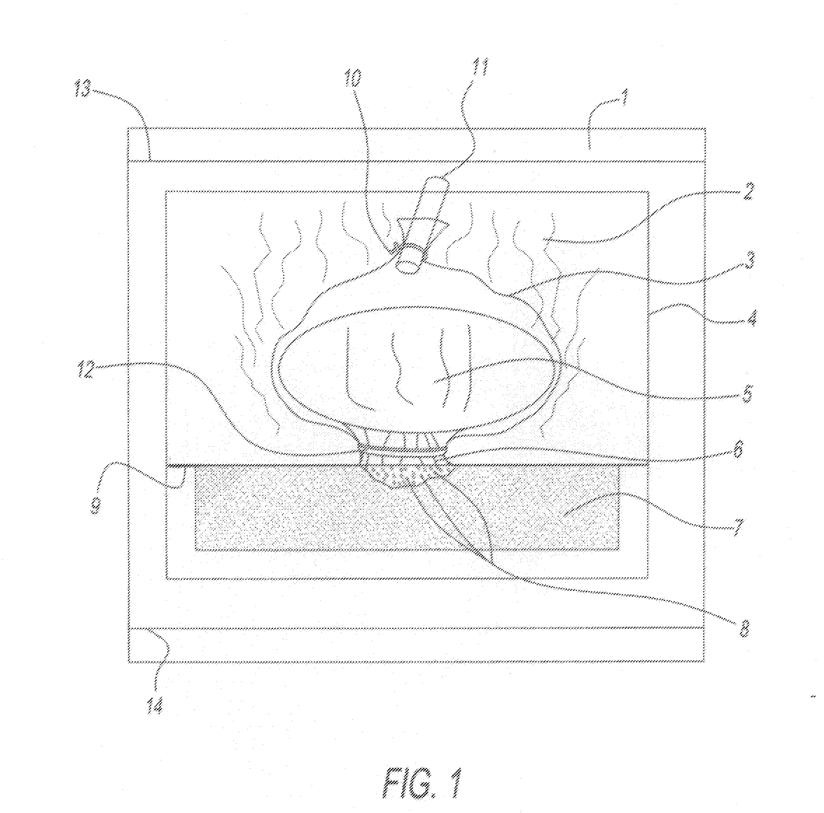

As depicted in the drawing, (FIG. 1) item 1 is a plastic bag which serves as a vacuum bag to provide for a vacuum environment to help in preservation. Placing lettuce in a vacuum will help to extend the useful life to up to two weeks in a refrigerated state, but that is the full extent of the preservation. As depicted further in the drawing, in item 2. water vapor will envelop the lettuce to help in preservation even while in a “vacuum” as it is not an absolute vacuum, but the standard vacuum of a common vacuum food preservation system. The plastic bag in item 3 shields the main lettuce body from the water so that it will be in a drier state. This forces the capillary action into the lettuce stem through the pricked holes depicted in item 8 which are also into the lettuce stem by up to 1″ length to help promote capillary action into the main lettuce body. The plastic container, item 4 holds the lettuce and water stationary and provides for strength of the packaging of sufficient width to not be crushed by the application of vacuum and of the approximate size of 6″×6″×5″. Item 5 is any leafy green vegetable including, but not limited to, Iceberg, Romaine, Butter or Boston, Spinach with the root base, Celery, Broccoli and even Cauliflower with the stem included, and other types of lettuce or leafy vegetables. As depicted in the drawing, item 6 is the stem of the lettuce which has been dipped into the water and optional salt mixture to allow for capillary action of the stem into the leaves of the vegetable. It has been pricked 3 to 4 times with a metal shaft like a needle, up to one inch in depth to provide for better capillary action. Item 7 is showing the liquid catalyst of water and optional iodized salt with optional food coloring. The mixture is optional 25% iodized salt content and 75% filtered or purified water. Item 9 is showing a plastic stop which is positioned slightly up from the bottom of the plastic container, to hold the stem of the lettuce in place in the center of the plastic container and inside the water. It will also keep the majority of the water in the lower portion of the container. Item 10 is a common twisty tie to tie the bag. Item 11 is a small ¼ inch plastic tube about 6 inches in length to hold the bag end and allow for air to escape as a vacuum and keep water from getting on the lettuce. Item 12 shows the extremely important rubber band that keeps the water from touching the lettuce, anywhere but in the pricked holes, and forces capillary action to help in preservation of the lettuce. Item 13 is simply the upper seal that will hold the vacuum and is accomplished by using the standard food preservation system which seals the external plastic bag together. item 14 is identical as 13, but is the lower seal.

I claim:

1. A method of preserving lettuce or other leafy vegetables in a fresh state without normal spoilage or degeneration for a minimum of 30 days and up to an undetermined number of days in a refrigerated environment and the crispness of the lettuce is maintained throughout the minimum 30 days of storage and to the variable/undetermined number of days.

2. A method of preserving lettuce or other leafy vegetables that changes no basic nutritional properties of the lettuce or leafy vegetable, and the only foreign substances introduced into the system are optional salt and optional green food coloring, in filtered or distilled water, while the moisture content and crispness of the lettuce and other leafy vegetables are maintained for the minimum of 30 days and the variable/undetermined number of days.

3. A method of preserving lettuce and other leafy vegetables comprising:
(a) A plastic container approximately 6″×6″×5″ holding the lettuce and water in a state that allows the moisture to enter the lettuce by capillary action;
(b) a flexible clear plastic tube of approximately ¼ inch gage and approximately three inches in length is inserted to provide for vacuum in a sealed plastic bag in a plastic container and ensure no water enters the sealed bag through the upper opening;
(c) pricked holes punched into the bottom of the plastic bag of up to one inch long into the lettuce stem promote the capillary action;
(d) an optional plastic stop that holds the lettuce stem in the water and in the center of the plastic container,
(e) a liquid catalyst consisting of filtered water and optional table salt and optional green food coloring, with a possible substitution of a cellulose sponge filled with the water, and porous paper filter over the sponge, and not as free flowing water;
(f) vacuum packaging.

4. Additional independent claim appropriate to the Second and Third Modified Protocols wherein the moisture content is stabilized and/or removed/depleted by “Reverse Capillary Action” to provide for greater freshness duration as depicted in FIGS. 1, 2 and 3 and is shown as the “Pricked Holes” which are depicted in all drawings.

5. Additional dependent claim appropriate to the Third Modified Protocol, of a deep cup with the approximate dimensions of 5″ deep and 4″ across at the top and 2.5″ across at the bottom to provide a “moisture reservoir” to help remove moisture and store it away from the lettuce stem. This cup is adjustable size depending on the type and size of the lettuce product.

6. Additional independent claim appropriate to the Third Modified Protocol of a Salt Packet or Loose Salt to act as a drying agent to provide for moisture suction in the Reverse Capillary Action Mode as depicted in FIG. 3, Item 4.
